(19) United States
(12) Patent Application Publication
(10) Pub. No.: US 2018/0032793 A1
(43) Pub. Date: Feb. 1, 2018

(54) APPARATUS AND METHOD FOR RECOGNIZING OBJECTS

(71) Applicant: SAMSUNG SDS CO., LTD., Seoul (KR)

(72) Inventors: Ki-Hoon HAN, Seoul (KR); Seong-Hwan CHO, Seoul (KR)

(73) Assignee: SAMSUNG SDS CO., LTD., Seoul (KR)

(21) Appl. No.: 15/665,776

(22) Filed: Aug. 1, 2017

(30) Foreign Application Priority Data
Aug. 1, 2016 (KR) 10-2016-0097836

(51) Int. Cl. G06K 9/00; G06K 9/32; G06T 7/73

(52) U.S. Cl. CPC G06K 9/00201; G06T 7/73; G06K 9/3241

(57) ABSTRACT

An apparatus and method for recognizing an object are provided. The apparatus for recognizing an object according to one embodiment of the present disclosure includes a recognizer configured to acquire an image of a target object and recognize the target object as an object of interest by comparing the image of the target object and previously learned information about the object of interest; and a determiner configured to receive a result of recognition of the target object from at least one of other object recognition apparatuses, which performs recognition of the target object and determines whether the target object is identical to the object of interest on the basis of the result of the recognition performed by the recognizer and the received recognition result.

### CROSS-REFERENCE TO RELATED APPLICATION

This application claims priority from Korean Patent Application No. 10-2016-0097836, filed on Aug. 1, 2016, the disclosure of which is incorporated herein by reference in its entirety.

### BACKGROUND

### 1. Field

Apparatuses and methods consistent with example embodiments relate to recognizing an object using a plurality of object recognition apparatuses.

### 2. Discussion of Related Art

An object recognition system has been developed as a technique for identifying objects using a machine. A conventional object recognition system recognizes an object by comparing stored images of the object and collected images. The success rate of the object recognition system is significantly lowered when the collected images are missing or corrupted. Thus, an attempt to increase the recognition rate by collecting various images or using an algorithm for recognizing similar images has been made. However, there is a limitation in collecting images, and using the algorithm to increase the recognition rate is expensive.

Accordingly, there exists a need to develop a highly reliable object recognition apparatus at low cost.

### SUMMARY

An objective of embodiments of the present disclosure is to provide a low-cost and highly reliable apparatus for recognizing an object.

According to an exemplary embodiment of the present disclosure, there is provided an apparatus for recognizing an object, including: a recognizer configured to acquire an image of a target object and recognize the target object as an object of interest by comparing the image of the target object and previously learned information about the object of interest; and a determiner configured to receive a result of recognition of the target object from at least one of other object recognition apparatuses, which performs recognition of the target object and determines whether the target object is identical to the object of interest on the basis of a result of the recognition performed by the recognizer and the received recognition result.

The apparatus may further include a learner configured to learn an image of the target object which is acquired by the recognizer and the at least one of other object recognition apparatuses as an information about the object of interest.

The recognizer may acquire an image of the target object in a different direction from that of the at least one of other object recognition apparatuses.

The recognizer may calculate a matching rate between the image of the target object and the object of interest and recognize the target object as the object of interest when the calculated matching rate is greater than or equal to a predetermined value, and the determiner receives a matching rate between the image of the target object and the object of interest from the at least one of other object recognition apparatuses.

The determiner may determine whether the target object is identical to the object of interest on the basis of a value obtained by dividing the sum of matching rates greater than or equal to the predetermined value among the calculated matching rate and the received matching rate by a total number of the apparatus and the at least one of other object recognition apparatuses.

When the determiner determines that the target object is identical to the object of interest and the recognizer fails to recognize the target object as the object of interest, the learner may learn the image of the target object acquired by the recognizer as an image of the object of interest.

When the determiner determines that the target object is identical to the object of interest and the recognizer fails to recognize the target object as the object of interest, the learner may receive an image of the target object from at least one of the at least one of other object recognition apparatuses and learn the received image as the image of the object of interest.

When the determiner determines that the target object is identical to the object of interest and the recognizer recognizes the target object as the object of interest, the learner may transmit the image of the target object which is acquired by the recognizer to the at least one of other object recognition apparatuses.

The learner may transmit a result of the learning to the at least one of other object recognition apparatuses, which is located at a position distinct from the apparatus and performs recognition of the target object.

According to another exemplary embodiment of the present disclosure, there is provided a method of recognizing an object which is performed by an object recognition apparatus comprising one or more processors and a memory configured to store one or more programs to be executed by the one or more processors, the method including: acquiring an image of a target object; recognizing the target object as a specific object of interest by comparing the acquired image of the target object and previously learned information about the object of interest; receiving a result of recognition of the target object from at least one of other object recognition apparatuses, which performs recognition of the target object; and determining whether the target object is identical to the object of interest on the basis of a result of the recognition of the target object and the received recognition result.

The method may further include, after the determining of whether the target object is identical to the object of interest, learning at least one of the acquired image and an image of the target object which is acquired by the at least one of other object recognition apparatuses as an information about the object of interest.

The acquiring of the image of the target object may include acquiring an image of the target object in a different direction from that of the at least one of other object recognition apparatuses.

The recognizing of the target object as the object of interest may include calculating a matching rate between the image of the target object and the object of interest and recognizing the target object as the object of interest when the calculated matching rate is greater than or equal to a predetermined value, wherein the result of the recognition of the target object which is received from the at least one of other object recognition apparatuses includes a matching rate between the image of the target object and the object of interest.

The determining of whether the target object is identical to the object of interest may include determining whether the target object is identical to the object of interest on the basis of a value obtained by dividing the sum of matching rates greater than or equal to the predetermined value among the calculated matching rate and the received matching rate by a total number of the object recognition apparatus and the at least one of other object recognition apparatuses.

The learning of the image of the target object may include learning the acquired image of the target object as an image of the object of interest when the target object is determined to be identical to the object of interest during the determining of whether the target object is identical to the object of interest but is not recognized as the object of interest during the recognizing of the target object.

The learning of the image of the target object may include receiving an image of the target object from the at least one of other object recognition apparatuses and learning the received image as the image of the object of interest when the target object is determined to be identical to the object of interest during the determining of whether the target object is identical to the object of interest but is not recognized as the object of interest during the recognizing of the target object.

The learning of the image of the target object may include transmitting the acquired image of the target object to the at least one of other object recognition apparatuses when the target object is determined to be identical to the object of interest during the determining of whether the target object is identical to the object of interest and is recognized as the object of interest during the recognizing of the target object.

The learning of the image of the target object may include transmitting a result of the learning to the at least one of other object recognition apparatuses, which is located at a position distinct from the object recognition apparatus and performs recognition of the target object.

### BRIEF DESCRIPTION OF THE DRAWINGS

The above and/or other objects, features and advantages of the present disclosure will become more apparent to those of ordinary skill in the art by describing example embodiments thereof in detail with reference to the accompanying drawings, in which:

FIG. 1 is an illustrative drawing for describing an operation of an object recognition apparatus according to an example embodiment;

FIG. 2 is a block diagram illustrating a detailed configuration of the object recognition apparatus according to an example embodiment;

FIG. 3 is a graph showing a recognition rate which is increased due to use of the object recognition apparatus according to an example embodiment;

FIG. 4 is a flowchart for describing a method of recognizing an object according to an example embodiment; and

FIG. 5 is a block diagram for describing a computing environment including a computing device suitable for use in an example embodiment.

### DETAILED DESCRIPTION OF EXEMPLARY EMBODIMENTS

Hereinafter, detailed example embodiments of the present disclosure will be described with reference to the accompanying drawings. The following detailed description is provided for a more comprehensive understanding of methods, devices and/or systems described in this specification. However, the methods, devices, and/or systems are only examples, and the present disclosure is not limited thereto.

In the description of the present disclosure, detailed descriptions of related well-known functions that are determined to unnecessarily obscure the gist of the present disclosure will be omitted. Some terms described below are defined in consideration of functions in the present disclosure, and meanings thereof may vary depending on, for example, a user or operator's intention or custom. Therefore, the meanings of terms should be interpreted based on the scope throughout this specification. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

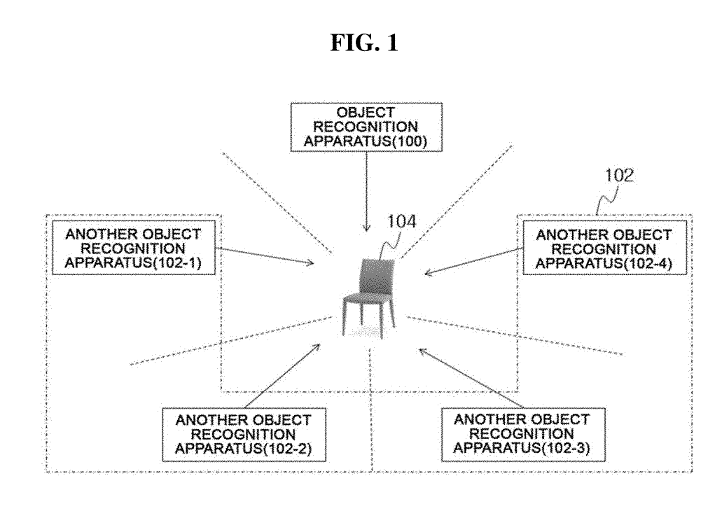

FIG. 1 is an illustrative drawing for describing an operation of an apparatus 100 for recognizing an object (hereinafter, referred to as an object recognition apparatus) according to an example embodiment. As shown in FIG. 1, the object recognition apparatus 100 according to an aspect of an example embodiment may recognize a target object 104 and determine whether the target object 104 is an object of interest to be identified on the basis of recognition results obtained from other object recognition apparatuses 102.

In the example embodiments described herein, the target object 104 may be, for example, a chair, but the present disclosure is not limited thereto, and the target object 104 may be any object as long as an image of a shape thereof can be obtained by an optical device such as a camera, a camcorder, or the like. In addition, the object of interest is an object to be identified and extracted, which may be identical to the target object or different from the target object. In one example, in the case of searching for prohibited items, stolen goods, and the like among possessions of passengers at an airport, target objects may be items carried by the passengers and objects of interest may be the prohibited items, stolen goods, and the like.

The object recognition apparatus 100 may include an optical device, such as a camera, a camcorder, or the like, and use the optical device to recognize the target object 104. Specifically, the object recognition apparatus 100 may recognize the target object 104 as an object of interest by comparing an obtained image of the target object 104 with previously stored information (e.g., an image, a video, or the like) related to the object of interest. Further, the object recognition apparatus 100 may receive results of recognition of the target object 104 from other object recognition apparatuses 102 and analyze the recognition results to ultimately determine whether the target object corresponds to the object of interest. Specifically, the object recognition apparatus 100 may update the previously stored information related to the object of interest on the basis of the result of the recognition of the target object 104 by the object recognition apparatus 100 and the received results of the recognition of the target object 104 by other object recognition apparatuses 102. Thereafter, the object recognition apparatus 100 may recognize the target object using the updated information related to the object of interest.

Each of other object recognition apparatuses 102 may be an apparatus which recognizes the target object 104. According to an aspect of an example embodiment, other object recognition apparatuses 102 may acquire an image of the target object 104 in a different direction from that of the object recognition apparatus 100. In this case, the image of the target object 104 may vary depending on an angle at which the target object 104 is viewed. Therefore, the object recognition apparatus 100 and other object recognition apparatuses 102 may obtain different recognition results even for the same target object.

However, each of other object recognition apparatuses 102 may be an apparatus configured to be the same as the object recognition apparatus 100 according to an example embodiment, but is not limited thereto, and may be an apparatus which simply recognizes only the target object. That is, other object recognition apparatuses 102 may not include a learner 206 which will be described below.

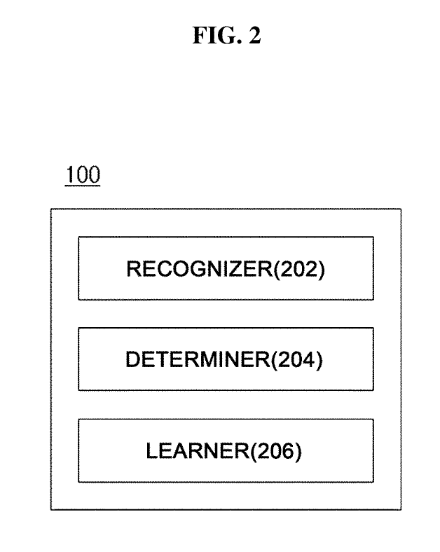

FIG. 2 is a block diagram illustrating a detailed configuration of the object recognition apparatus 100 according to an example embodiment. As shown in FIG. 2, the object recognition apparatus 100 may include a recognizer 202, a determiner 204, and the learner 206. Each of the components and modules of the object recognition apparatus 100 as shown in FIG. 100 and other figures may be implemented with hardware (e.g., a processor, a computer-readable storage medium, etc.), software (e.g. a computer program instructions), or a combination of both.

The recognizer 202 is a module which recognizes the target object 104. Specifically, the recognizer 202 may acquire an image of the target object 104 and recognize the target object 104 on the basis of the acquired image. The recognizer 202 may recognize the target object 104 as an object of interest. In other words, the recognizer 202 may autonomously determine whether the target object 104 is the object of interest.

To this end, the recognizer 202 may include an optical device such as a camera, a camcorder, or the like. According to an aspect of an example embodiment, the recognizer 202 may acquire the image of the target object 104 by photographing the target object 104 using the optical device. In addition, the recognizer 202 may acquire the image of the target object 104 in a different direction (e.g., different viewing angle) from that of other object recognition apparatuses 102. In other words, the object recognition apparatus 100 and other object recognition apparatuses 102 according to an example embodiment may acquire images of the target object 104 from different angles.

The recognizer 202 may compare the acquired image of the target object 104 with previously learned information about the object of interest. The previously learned information about the object of interest may be information to be considered for determining whether the target object 104 is the object of interest, and may include, for example, a group of images of the object of interest. The recognizer 202 may compare the image of the target object and the object of interest using a conventional object recognition algorithm. According to an aspect of an example embodiment, the recognizer 202 may calculate a matching rate between the image of the target object 104 and the object of interest and may recognize the target object 104 as the object of interest when the calculated matching rate is greater than or equal to a predetermined value (e.g., 0.75 or 0.8). Conversely, when the calculated matching rate is less than or equal to the predetermined value, the recognizer 202 may recognize the target object 104 as an object of non-interest. A matching rate may be an objective measurement of how closely the image of the target object 104 resembles the object of interest, where the matching rate of 0 represents no resemblance and the matching rate of 1 represents a complete match.

The determiner 204 is a module which ultimately determines whether the target object 104 is an object of interest by considering the results of the recognition of the target object 104 by other object recognition apparatuses 102 in addition to the result of the recognition performed by the object recognition apparatus 100.

The determiner 204 may receive the recognition results of the target object 104 from other object recognition apparatuses 102. The determiner 204 may receive information about the matching rate between the target object 104 and the object of interest from other object recognition apparatuses 102. In other words, the received result of the recognition of the target object 104 by other object recognition apparatuses 102 may include information about whether the target object 104 corresponds to the object of interest as well as information about the matching rate between the target object 104 and the object of interest.

The determiner 204 may determine whether the target object 104 corresponds to the object of interest on the basis of the result of recognition autonomously performed by the object recognition apparatus 100, that is, the recognizer 202, in addition to the recognition result received from other object recognition apparatuses 102.

According to an aspect of an example embodiment, when any matching rate among the matching rate calculated by the recognizer 202 and the matching rates received from other object recognition apparatuses 102 are greater than or equal to a predetermined value (e.g., 0.75 or 0.8), the sum of the matching rates may be divided by the total number of the object recognition apparatus 100 and other object recognition apparatuses 102, and on the basis of the resulting value (hereinafter, referred to as an “allowable matching rate”), the determiner 204 may determine whether the target object 104 corresponds to the object of interest. Specifically, the determiner 204 may determine that the target object 104 corresponds to the object of interest when the allowable matching rate is greater than or equal to the predetermined threshold value (e.g., 0.75, 0.8, or the like).

For example, it is assumed that the object recognition apparatus 100 and four other object recognition apparatuses 102-1, 102-2, 102-3, and 102-4 recognize the target object. In this case, it is also assumed that matching rates between the target object and the object of interest, which are obtained from the total of five apparatuses, are 0.9834, 0.8843, 0.9654, 0.9492, and 0.3213, and when the matching rate obtained by each of the object recognition apparatuses 100 and 102 is greater than or equal to a threshold value (e.g., 0.75), the corresponding object recognition apparatuses autonomously determines that the target object corresponds to the object of interest. In this example, the allowable matching rate may be a value obtained by dividing the sum of the matching rates (e.g., 0.9834, 0.8843, 0.9654, and 0.9492) obtained from the object recognition apparatuses 100 and/or 102 which determine that the target object corresponds to the object of interest by the object recognition apparatuses 100 and 102. In this case, the allowable matching rate is 0.75646, i.e., (0.9834+0.8843+0.9654+0.9492)/5. In the case in which the determiner 204 ultimately determines that the target object corresponds to the object of interest when the allowable matching rate is greater than or equal to the threshold value (e.g., 0.75), the determiner 204 in the above example may determine that the target object corresponds to the object of interest.

According to an aspect of an example embodiment, whether the target object is identical to the object of interest is determined by considering the result of the recognition of the target object 104 by the recognizer 202 of the object recognition apparatus 100 as well as the recognition results received from other object recognition apparatuses 102 so that reliability of the recognition result of the target object 104 may be increased.

Meanwhile, although the recognizer 202 and the determiner 204 are shown separately in FIG. 1 for illustrative purposes, it should be appreciated that the recognizer 202 and the determiner 204 may be integrated into a single configuration according to some example embodiments.

The learner 206 is a module for learning information about the object of interest. According to an aspect of an example embodiment, the learner 206 may learn an acquired image of the target object 104 as the information about the object of interest according to the determination result obtained from the determiner 204. In other words, the learner 206 may learn images of the target object 104 acquired from the recognizer 202 and at least one of other object recognition apparatuses 102 as the information about the object of interest. Specifically, the learner 206 may pre-store (e.g., store before the recognizer 202 acquires images of the target object 104) the information about the object of interest. In this case, the information about the object of interest may be a group of images corresponding to the object of interest. In addition, the object recognition apparatus 100 may include a database for storing the information about the object of interest. Then, the learner may update the information about the object of interest using image of the target object 104 acquired by the recognizer or received from any of other object recognition apparatuses 102. In other words, the learner 206 may store the acquired or received images as images of the object of interest which are viewed from different directions and different angles. Accordingly, the learner 206 may collect various images according to the positions and angles at which the object of interest is photographed, and the recognizer 202 may accurately recognize the object of interest using the collected images. Hereinafter, a process of the learner 206 learning the image of the target object 104 will be described in detail.

According to an aspect of an example embodiment, when the determiner 204 determines that the target object 104 corresponds to the object of interest and the recognizer 202 fails to recognize the target object 104 as the object of interest, the learner 206 may learn (e.g., through machine learning, without the knowledge that the target object 104 is an object of interest being explicitly programmed) an image of the target object 104 acquired by the recognizer 202 as an image of the object of interest. Specifically, when the recognizer 202 fails to recognize the target object 104 as the object of interest while the determiner 204 determines that the target object 104 corresponds to the object of interest, the learner 206 may learn the image acquired by the recognizer 202 as the image of the object of interest. In addition, in an example embodiment, the learner 206 may receive an image of the target object 104 acquired by other object recognition apparatus 102 and learn the received image of the target object 104 as the image of the object of interest. In this case, the received image of the target object 104 may be an image of the target object 104 that is photographed at a different angle from the image of the target object 104 acquired by the recognizer 202.

When the determiner 204 determines that the image of the target object 104 acquired by the recognizer 202 is the image of the object of interest, the learner 206 may transmit the acquired image to other object recognition apparatuses 102. According to an aspect of an example embodiment, when the determiner 204 determines that the target object 104 corresponds to the object of interest and the recognizer 202 recognizes the target object 104 as the object of interest, the learner 206 may transmit the image of the target object 104 acquired by the recognizer 202 to other object recognition apparatuses 102. According to an aspect of an example embodiment, the learner 206 may transmit the image acquired by the recognizer 202 to other object recognition apparatuses 102 only when the determiner 204 determines that the target object 104 corresponds to the object of interest and the recognizer 202 recognizes the target object 104 as the object of interest. However, the present disclosure is not limited thereto, and the learner 206 may transmit the acquired image to other object recognition apparatuses 102 regardless of the determination result. In this case, the learner 206 may selectively learn the images received from other object recognition apparatuses 102. It is enough for the object recognition apparatus 100 to be able to share the images with other object recognition apparatuses 102, and a manner of sharing the images is not particularly limited. According to example embodiments of the present disclosure, it is possible to easily collect images according to a position and angle at which the object of interest is photographed by sharing the images acquired by the object recognition apparatus and other object recognition apparatuses.

The learner 206 may transmit the learning result to another object recognition apparatus, which is located at a position distinct from the object recognition apparatus 100 and recognizes the target object 104. In this case, the distinct position may refer to a position which is distant enough (e.g., above a threshold value) from the object recognition apparatus 100 so that the target object, which is located in one direction therefrom, is not photographed by an optical device provided in another direction. In addition, the learning result may be an image related to the object of interest and may include the acquired image and the received images. In other words, the learner 206 may transmit the acquired image and the received images to another object recognition apparatus that has not yet acquired an image of the target object 104. In this case, the learner 206 may transmit information on a corresponding object of interest (e.g., a name of the object of interest, identification information thereof, etc.), with the acquired image and the received images. Accordingly, each of other object recognition apparatuses may be allowed to immediately recognize the target object using the received images without needing to learn the object of interest or determine whether the target object corresponds to the object of interest.

According to example embodiments of the present disclosure, since the object recognition apparatuses share recognition results and learn the information about the target object through the shared recognition results, it is possible to improve accuracy of the recognition rate of the target object. In addition, it is possible to improve the recognition rate of the object recognition apparatus 100 at low cost by utilizing existing optical devices such as a camera, a camcorder, or the like.

However, the recognizer 202, the determiner 204, and the learner 206 are only distinguished functionally, and each configuration is not necessarily implemented as a separate hardware component. In other words, two or more of the recognizer 202, the determiner 204, and the learner 206 may be implemented as a single piece of hardware (e.g., a processor), a software module (e.g., instructions stored in a computer-readable storage medium), or a combination of both. Alternatively, the recognizer 202, the determiner 204, and the learner 206 may be each implemented with its own hardware module, a software module, or a combination of both.

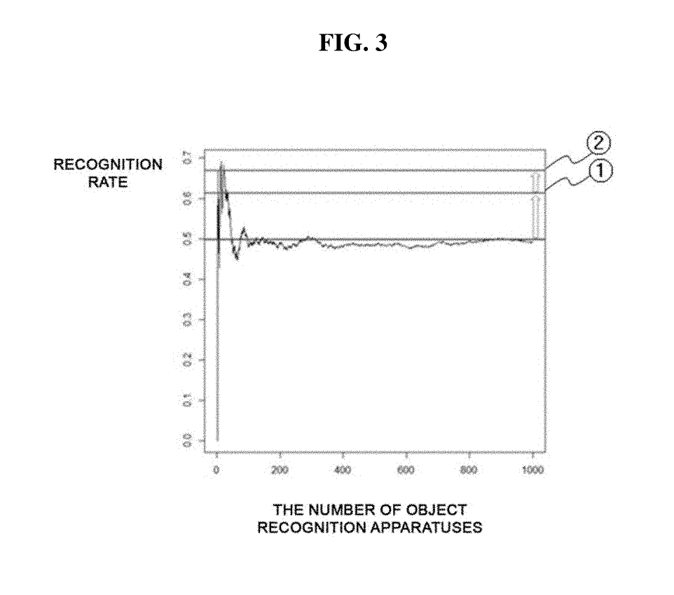

FIG. 3 is a graph showing a recognition rate which is increased due to the use of the object recognition apparatus 100 according to an example embodiment. FIG. 3 shows a result of a simulation performed under the assumption that the object recognition rate of the object recognition apparatus 100 is 50% (or 0.5). The object recognition rate may refer to reliability of the result of recognition of the target object 104 by the object recognition apparatus 100. For example, a high object recognition rate indicates that the object recognition apparatus 100 accurately recognizes the target object 104 as the object of interest. Thus, the match rate may indicate a determination, by a machine, of how much an image of an object resembles an object of interest, while the object recognition rate may indicate the probability of the machine actually correctly recognizing the object in the image to be the object of interest.

As shown in FIG. 3, as the number of object recognition apparatuses increases, an object recognition rate by the plurality of object recognition apparatuses may converge to the object recognition rate of the object recognition apparatus 100 (e.g., 0.5).

Then, after the object recognition apparatus 100 performs learning once, an object recognition rate \textcircled{1} for the plurality of object recognition apparatuses may increase above 0.5. Then, after the object recognition apparatus 100 performs the learning one more time, an object recognition rate \textcircled{2} for the plurality of object recognition apparatuses may further increase.

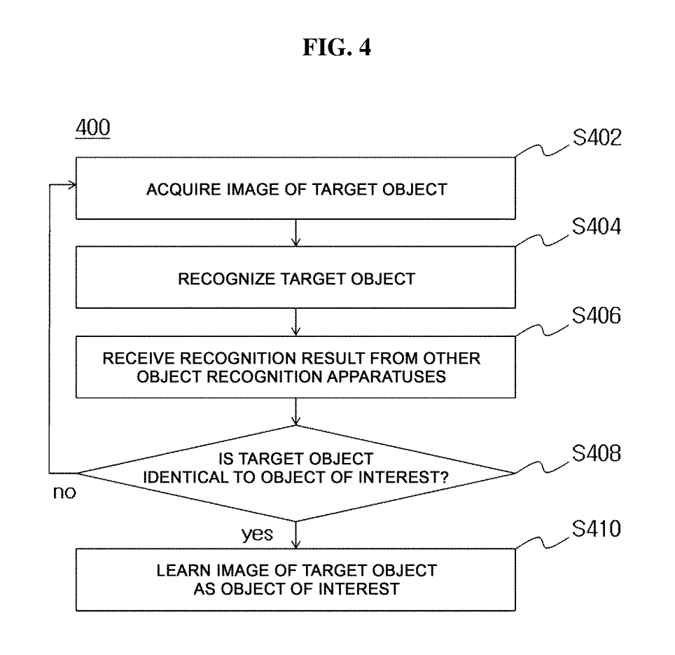

FIG. 4 is a flowchart for describing a method 400 of recognizing an object according to an example embodiment. The method shown in FIG. 4 may be performed by the above-described object recognition apparatus 100. Although the method shown in the flowchart is divided into a plurality of operations, the operations may be combined and concurrently performed, some operations may be omitted or further divided into more operations, or any operation that is not shown in the flowchart may be added and performed.

The recognizer 202 may acquire an image of a target object (S402). The target object 104 may be, for example, a chair as an object to be identified, but the present disclosure is not limited thereto, and the target object 104 may include any object as long as an image of a shape thereof can be obtained by an optical device such as a camera, a camcorder, or the like. According to an aspect of an example embodiment, the recognizer 202 may acquire the image of the target object 104 in a different direction (e.g., from a different viewing angle) from that of at least one of other object recognition apparatuses 102. Accordingly, the object recognition apparatus 100 and other object recognition apparatuses 102 may acquire images according to a respective angle at which the target object is viewed.

Then, the recognizer 202 may recognize the target object 104 as an object of interest by comparing the acquired image of the target object 104 and previously learned information about the object of interest (e.g., an image or a video of the object of interest) (S404). The object of interest may be an object to be recognized and extracted, and may be identical to or different from the target object 104. The recognizer 202 may calculate a matching rate between the image of the target object 104 and the object of interest and recognize the target object 104 as the object of interest when the matching rate is greater than or equal to a predetermined value.

Then, the determiner 204 may receive a result of recognition of the target object 104 from at least one of the other object recognition apparatuses 102, which recognize the target object 104 (S406). In this case, the recognition result of the target object 104 may include the matching rate (e.g., 0.8843, 0.9654, etc.) between the image of the target object 104 and the object of interest.

Then, the determiner 204 may determine whether the target object 104 corresponds to the object of interest on the basis of the recognition result of the target object 104 and the received recognition result (S408). Specifically, the determiner 204 may determine whether the target object 104 corresponds to the object of interest on the basis of a value obtained by dividing the sum of matching rates that are greater than or equal to the predetermined value among the calculated matching rate and the received matching rates by the total number of the object recognition apparatus 100 and the at least one of other object recognition apparatuses 102.

Then, when the determiner 204 determines that the target object 104 is corresponds the object of interest, the learner 206 may learn images of the target object 104 acquired from the recognizer 202 and at least one of other object recognition apparatuses 102 as the information about the object of interest (S410). When the determiner 204 determines that the target object 104 corresponds to the object of interest and the recognizer 202 fails to recognize the target object 104 as the object of interest, the learner 206 may learn the image of the target object 104 acquired by the recognizer 202 as an image of the object of interest. In this case, the learner 206 may receive an image of the target object 104 from at least one of other object recognition apparatuses 102 and learn the image as the image of the object of interest. In addition, when the determiner 204 determines that the target object 104 corresponds to the object of interest and the recognizer 202 recognizes the target object 104 as the object of interest, the learner 206 may transmit the image of the target object 104 acquired by the recognizer 202 to at least one of the other object recognition apparatuses 102. In this case, other object recognition apparatuses 102 may learn the image transmitted from the object recognition apparatus 100. Meanwhile, the learner 206 may transmit the learning result to at least one of other object recognition apparatuses, which is located at a position distinct from the object recognition apparatus 100 and recognize the target object 104. Here, the learning result may be a group of images related to the target object 104. Accordingly, other object recognition apparatuses that have not yet acquired the image of the target object 104 may accurately recognize the object of interest through the learning result only.

Meanwhile, according to an aspect of an example embodiment, when the determiner 204 determines that the target object 104 does not correspond to the object of interest, the recognizer 202 may acquire a new image of the target object 104 and perform recognition of the target object 104.

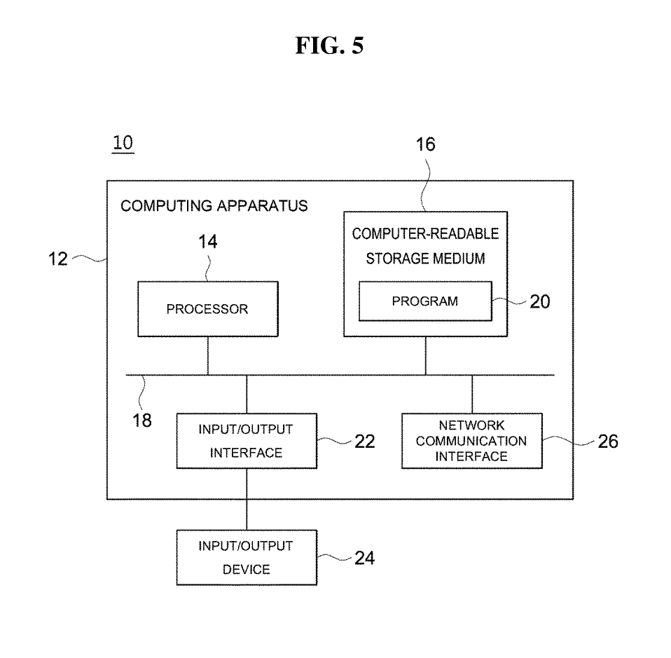

FIG. 5 is a block diagram for describing a computing environment 10 including a computing device suitable for use in an example embodiment. That is, FIG. 5 is a diagram for describing a hardware aspect for implementing an example embodiment. Each component may have a different function or capability other than those described hereinafter, and, in addition to components that will be described hereinafter, other components may be further included.

The illustrated computing environment 10 includes a computing device 12. In an example embodiment, the computing device 12 may be the object recognition apparatus 100. In addition, the computing device 12 may be each of the other object recognition apparatuses 102.

The computing device 12 may include at least one processor 14, a computer-readable storage medium 16, and a communication bus 18. The processor 14 may operate according to one or more of the above-described example embodiments. For example, the processor 14 may execute one or more programs 20 stored in the computer-readable storage medium 16. The one or more programs may include one or more computer-executable instructions, and when the computer-executable instructions are executed by the processor 14, the computing device 12 may perform the operations according to an example embodiment. The processor 14 may be, for example, a central processing unit (CPU), an application processor (AP), a system on a chip (SoC), an application-specific integrated circuit (ASIC), etc.

The computer-readable storage medium 16 may be configured to store computer-executable instructions, program code, program data, and/or other suitable forms of information. The programs 20 stored in the computer-readable storage medium 16 may include a group of instructions executable by the processor 14. The computer-readable storage medium 16 may include a memory (a volatile memory such as a random access memory (RAM), a non-volatile memory, or a suitable combination thereof), one or more magnetic disk storage devices, optical disk storage devices, flash memory devices, other forms of storage media accessible by the computing device 12 and capable of storing desired information, or any suitable combination thereof.

The communication bus 18 interconnects various components of the computing device 12 including the processor 14 and the computer-readable storage medium 16.

The computing device 12 may include one or more network communication interfaces 26 and one or more input/output interfaces 22 for one or more input/output devices 24. The input/output interface 22 and the network communication interface 26 are connected to the communication bus 18. The input/output device 24 may be connected to other components of the computing device 12 through the input/output interface 22. The illustrative input/output device 24 may include a pointing device (e.g., a mouse or a track pad), a keyboard, a touch input device (e.g., a touch pad or a touch screen), a voice or sound input device, input devices such as various types of sensor devices and/or a photographing device, and/or output devices such as a display device, a printer, a speaker, and/or a network card. The illustrative input/output device 24 may be included within the computing device 12 as one component included in the computing device 12 or may be connected to another computing device 102 as a separate device distinct from the computing device 12. The network communication interface 26 may be, for example, a modem, a network interface controller (NIC), a network adapter, an antenna, etc.

According to example embodiments of the present disclosure, since whether a target object is identical to an object of interest is determined by comprehensively considering a result of recognition of the target object by an object recognition apparatus and a recognition result received from another object recognition apparatus, it is possible to improve reliability of the recognition result of the target object.

In addition, according to the example embodiments of the present disclosure, it is possible to easily collect images of each angle of the object of interest by sharing images of the object of interest acquired by object recognition apparatus and other object recognition apparatuses respectively.

Moreover, according to the example embodiments of the present disclosure, since the object recognition apparatuses share recognition results of the target object and learn information about the target object through the shared recognition results, it is possible to improve accuracy of the recognition rate of the target object.

Furthermore, according to the example embodiments of the present disclosure, an object recognition apparatus which has not actually photographed the target object may easily recognize the object of interest by receiving learning results of other object recognition apparatuses being shared therewith.

Although example embodiments of the present disclosure have been described in detail, it should be understood by those skilled in the art that various changes may be made without departing from the spirit or scope of the present disclosure. Therefore, the scope of the present disclosure is to be determined by the following claims and their equivalents, and is not restricted or limited by the foregoing detailed description.

What is claimed is:

1. An apparatus for recognizing an object, comprising:
a memory configured to store computer-readable instructions; and
a processor configured to execute the computer-readable instructions, which when executed cause the processor to be configured to implement:
a recognizer configured to acquire a first image of a target object and perform a first recognition process of recognizing the target object as an object of interest by comparing the first image of the target object and previously learned information about the object of interest; and
a determiner configured to receive a result of a second recognition process of the target object from at least one of other object recognition apparatuses, which performs the second recognition process of the target object, and determine whether the target object corresponds to the object of interest based on a result of the first recognition process and the result of the second recognition process.

2. The apparatus of claim 1, wherein the processor, when executing the computer-readable instructions, is further configured to implement a learner configured to learn, by machine learning, that the first image of the target object which is acquired by the recognizer and a second image acquired by the at least one of the other object recognition apparatuses to be corresponding to the object of interest.

3. The apparatus of claim 2, wherein the first image of the target object is associated with a first viewing angle and the second image is associated with a second viewing angle different from the first viewing angle.

4. The apparatus of claim 2, wherein the recognizer is further configured to calculate a first matching rate between the first image of the target object and the object of interest and recognize the target object as the object of interest in response to the first matching rate being greater than or equal to a predetermined value, and
wherein the determiner is further configured to receive a second matching rate between the second image of the target object and the object of interest from the at least one of the other object recognition apparatuses.

5. The apparatus of claim 4, wherein the determiner is further configured to determine whether the target object corresponds to the object of interest based on a value obtained by dividing a sum of matching rates, from among the first matching rate and the second matching rate, that are greater than or equal to the predetermined value by a total number of the apparatus and the at least one of the other object recognition apparatuses.

6. The apparatus of claim 5, wherein, when the determiner determines that the target object corresponds to the object of interest and the recognizer fails to recognize the target object as the object of interest, the learner learns the first image of the target object acquired by the recognizer as corresponding to the object of interest.

7. The apparatus of claim 6, wherein, in response to the determiner determining that the target object corresponds to the object of interest and the recognizer failing to recognize the target object as the object of interest, the learner receives the second image of the target object from the at least one of the other object recognition apparatuses and learns the second image as corresponding to the object of interest.

8. The apparatus of claim 5, wherein, in response to the determiner determining that the target object corresponds to the object of interest and the recognizer recognizing the target object as the object of interest, the learner transmits the first image of the target object to the at least one of the other object recognition apparatuses.

9. The apparatus of claim 2, wherein the learner is further configured to transmit a result of the learning to the at least one of the other object recognition apparatuses, each of which is located at a position distinct from the apparatus and performs the second recognition process of the target object.

10. A method of recognizing an object by an object recognition apparatus comprising one or more processors and a memory configured to store one or more programs to be executed by the one or more processors, the method comprising:
acquiring a first image of a target object;
performing a first recognition process of recognizing the target object as an object of interest by comparing the first image of the target object and previously learned information about the object of interest;
receiving a result of a second recognition process of the target object from at least one of other object recognition apparatuses, which performs the second recognition process of the target object; and
determining whether the target object corresponds to the object of interest based on a result of the first recognition process and the result of the second recognition process.

11. The method of claim 10, further comprising, after the determining of whether the target object corresponds to the object of interest, learning, by machine learning, that at least one of the first image and a second image of the target object which is acquired by the at least one of the other object recognition apparatuses to be corresponding to the object of interest.

12. The method of claim 11, wherein the acquiring the first image of the target object comprises acquiring the first image of the target object from a different viewing angle from the at least one of the other object recognition apparatuses.

13. The method of claim 11, wherein the first recognition process comprises:
calculating a first matching rate between the first image of the target object and the object of interest: and
recognizing the target object to be corresponding to the object of interest in response to the first matching rate being greater than or equal to a predetermined value,
wherein the result of the second recognition process of the target object which is received from the at least one of the other object recognition apparatuses includes a second matching rate between the second image of the target object and the object of interest.

14. The method of claim 13, wherein the determining of whether the target object corresponds to the object of interest comprises determining whether the target object corresponds to the object of interest based on a value obtained by dividing a sum of matching rates, from among the first matching rate and the second matching rate, greater than or equal to the predetermined value by a total number of the object recognition apparatus and the at least one of the other object recognition apparatuses.

15. The method of claim 14, wherein the learning that the at least one of the first image and the second image to be corresponding to the object of interest comprises learning that the first image of the target object to be corresponding to the object of interest in response to the target object being determined to correspond to the object of interest and the target object being not recognized as the object of interest during the first recognition process.

16. The method of claim 15, wherein the learning that the at least one of the first image and the second image to be corresponding to the object of interest further comprises receiving the second image of the target object from the at least one of the other object recognition apparatuses, and learning the second image as corresponding to the object of interest in response to the target object being determined to correspond to the object of interest and the target object being not recognized as the object of interest during the first recognition process.

17. The method of claim 14, wherein the learning that the at least one of the first image and the second image to be corresponding to the object of interest further comprises transmitting the first image of the target object to the at least one of the other object recognition apparatuses in response to the target object being determined to correspond to the object of interest and the target object being recognized as the object of interest during the first recognition process.

18. The method of claim 11, wherein the learning that the at least one of the first image and the second image to be corresponding to the object of interest further comprises transmitting a result of the learning to the at least one of the other object recognition apparatuses, each of which is located at a position distinct from the object recognition apparatus and performs the second recognition process of the target object.
